(19) United States
(12) Patent Application Publication
(10) Pub. No.: US 2014/0324496 A1
(43) Pub. Date: Oct. 30, 2014

(54) PROJECT MANAGEMENT APPLICATION INCLUDING COMPETENCY SEARCH CAPABILITY

(71) Applicant: Oracle International Corporation, Redwoods Shores, CA (US)

(72) Inventor: Se-Yong Jun, Redwood City, CA (US)

(73) Assignee: Oracle International Corporation, Redwoods Shores, CA (US)

(21) Appl. No.: 14/151,397

(22) Filed: Jan. 9, 2014

Related U.S. Application Data
(60) Provisional application No. 61/815,516, filed on Apr. 24, 2013.

(51) Int. Cl. G06Q 10/06

(52) U.S. Cl. CPC G06Q 10/063112
USPC 705/7.14

(57) ABSTRACT

A project management application includes tables associating tasks, human resources, and competencies and provides for searching by a competency to find human resources having the competency or the tasks utilizing the competency, searching by human resource to find the competencies had by the human resource or the tasks to which the human resource has been assigned; or searching by task name to determine which human resources or competencies were utilized on a task. A common interface is used with the project management application.

### CROSS REFERENCES TO RELATED APPLICATIONS

This application claims priority from U.S. Provisional Patent Application Ser. No. 61/815,516, entitled SEARCH CAPABILITY FOR EMPLOYEE TO FIND EXPERTS BY PROJECT TASK MANAGEMENT SOLUTIONS, filed on Apr. 24, 2013, which is hereby incorporated by reference as if set forth in full in this application for all purposes.

### BACKGROUND

In many large enterprises, a project manager is responsible for planning and executing a project and forming a project team that includes the team members responsible for executing project tasks and producing deliverables during the lifecycle of the project.

The project manager may request a human resource, such as an employee of the enterprise who has particular competencies, to be added as a team member to perform tasks related to completion of the project. These competencies can include expertise in using specified technologies, such as, for example, SOAP, HTML or web services, or a skills, for example, knowledge of French or knowledge of electromagnetic theory. Such a request may be referred to as a resource request. The resource request also specifies the lifecycle of the project to limit responses to human resources available during the lifecycle of the project.

A resource manager of the enterprise may respond to the resource request by searching through records of the enterprise's employees or using a network forum to identify one or more employees who are available and who have some or all of the competencies requested by the project manager. The resource manager may be required to further evaluate these identified employees by talking to the identified employees, discussing identified employees with their current managers, receiving input from other persons, and/or gathering additional information before any of the identified employees may be assigned to fulfill the resource request.

Current project management applications do not identify competencies required to complete project tasks and human resources having qualifications relating to identified competencies. For example, in the IT industry it is often necessary to share knowledge with colleagues in order to improve team performance. Currently, many applications provide project management and resource management methods, but those methods are not coordinated to provide a unified method for a user to search and utilize project management and resource management methods together.

Therefore, in many instances, engineers who are project team members try to find information relating to human resources having a competency needed to complete a project task by using a networked forum and/or by raising questions during meetings to find resources having a specific, required competency. In either case valuable working hours are wasted trying to find the needed human resources.

### SUMMARY

In example embodiments, team members working on a task of a project can query the project management application for a particular competency to find an expert to help with questions or to work on the project. The project manager and team members working on a task can associate competency information with the task.

In some example embodiments, this competency information is then searchable so others working on a similar task can leverage existing expertise, share knowledge, and improve team performance without extra effort. The project management application includes logic that allows the project manager to associate individual tasks with a competency and to assign team members to the task. The logic also allows team members to associate their own competencies with the task to which they are assigned. This logic enables other enterprise personnel to find an expert having a required competency and enables the project manager to manage employees' competencies by searching for competencies without leaving the project management application.

A further understanding of the nature and the advantages of particular embodiments disclosed herein may be realized by reference to the remaining portions of the specification and the attached drawings.

### BRIEF DESCRIPTION OF THE DRAWINGS

FIG. 1 illustrates a block diagram of an example embodiment;

FIG. 2 illustrates an example GUI configured to associate and disassociate competencies with tasks;

FIGS. 3A-3C illustrate example database tables configured to associate and disassociate competencies with tasks;

FIG. 4 illustrates an example UI widget configured to search for human resources having selected competencies to work on selected tasks;

FIGS. 5A-5B illustrate example database tables configured to search for human resources having selected competencies to work on selected tasks;

FIGS. 6-8 are flow charts illustrating processes performed by example embodiments; and

FIG. 9 illustrates an example computer system configured to implement example embodiments.

### DETAILED DESCRIPTION OF EMBODIMENTS

Although the invention has been described with respect to particular embodiments thereof, these particular embodiments are merely illustrative, and not restrictive.

In one example embodiment, a pre-seeded competency set, including skills and technologies, is provided when the project manager creates a task. The use of the pre-seeded competency set is optional and the competency set can be changed any time when a project is active. In addition, when a task is assigned to a team member (the task owner), the task owner can add/modify/remove competencies that the task owner is using in the task. The competency set may be stored in a separate permanent location (e.g., a database table separate from project or task tables).

An example database to store the competency set used in the task stores at least the following information: (1) an identifier to find the task, (2) an identifier to find the resource who worked on the task, i.e., the task owner, and (3) an identifier to find details of the competency set.

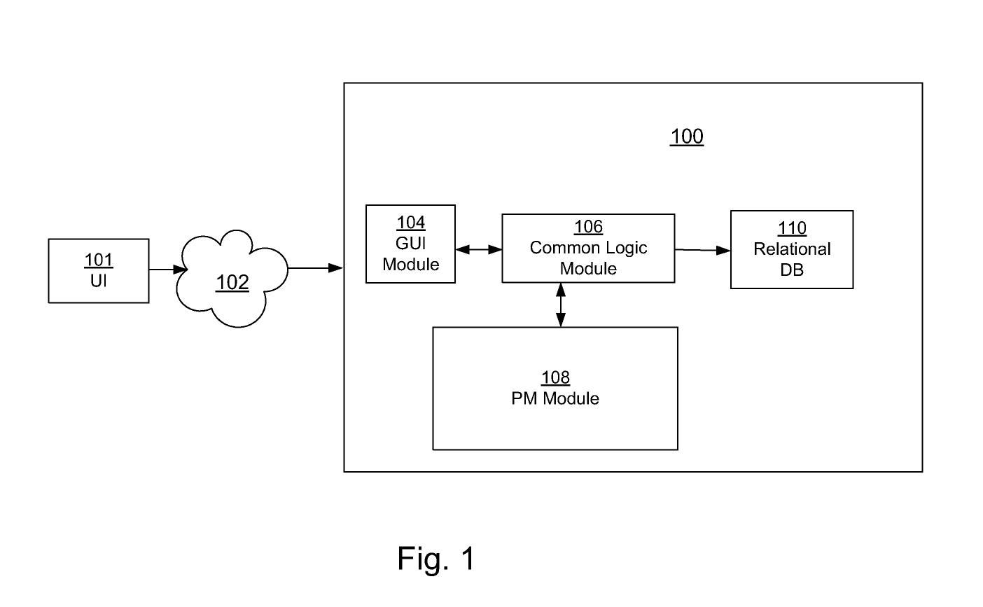

FIG. 1 is a block diagram of an example embodiment. In FIG. 1 an example project management application 100 is coupled to a user interface (UI) 101 by, for example, a network 102 which may be a Local Area Network (LAN), a Wide Area Network (WAN) or the Internet.

In an example embodiment, the project management application 100 is a computer system or other computerized device operated by a project manager or other user submitting a resource request. In the following a computer system may be any collection of computing resources used to perform one or more tasks involving computer processing. An example enterprise computing environment includes various computing resources distributed across a network and may further include private and shared content on Intranet Web servers, databases, files on local hard discs or file servers, email systems, document management systems, portals, and so on.

The project management application 100 may be used to create tasks required to complete a project, to create and submit a resource request, to assign human resources to tasks and to schedule the completion of tasks during the life cycle of the project. A resource request may be a request for the services of a person, such as an employee of an enterprise.

A project manager or some other system user may create a resource request using the UI 101 to connect to project management application 100. The resource request may specify various qualifications that the resource is required and/or desired to possess. For instance, the resource request may specify a time period during which the resource is requested to be available. The resource request may also specify competencies, such as knowledge of computer programming languages, in which the resource is expected to be proficient. Other qualifications may include a physical location, a job title, language skills, degrees, etc. Based on the enterprise on behalf of which the project manager is procuring the resource, the types of qualifications requested may vary.

As an example of when a user such as a project manager may need to request an employee through a resource request, consider a large engineering company. Such a company may have thousands of employees scattered across many projects, each project with varying and changing needs.

In existing systems, when a project manager needs a person to perform a particular task, such as programming code in a particular computing language, the project manager may contact other project managers directly in search of the person or submit a resource request stating the competencies required to another party, referred to as a resource manager. The resource manager is then responsible for finding an appropriate employee to fill the resource request.

The example embodiments described below facilitate the searching of human resources having needed competencies to complete a task by the project manager or team members without leaving the project management application.

In this example, the project management application 100 includes a user interface (UI) 101, a Graphical User Interface (GUI) Module 104, a common logic module 106, a project management (PM) module 108 and a relational database 110.

The UI 101 includes one or more UI controls which may be any displayed element or component of a user interface display screen which is adapted to enable a user to provide input. Examples of user interface controls include buttons, drop down menus, menu items, hyperlinks, and so on. For example, the UI 101 and GUI module 104 may use widgets to transfer data between the user and the project management application. A widget is an element that the user interacts with on the user interface and is adapted to facilitate manipulating, interacting with, and/or viewing a particular collection of or type of data. The widget may be thought of as a control for the user in the GUI and may provide an interaction point for the manipulation of a collection of data or a particular kind of data.

The PM module 108 provides tools to allow the user to plan, organize, motivate, and control resources to achieve specific goals. Some functions of the PM module 108 are to define tasks required to reach the goal and assign human resources as team members. In the following a human resource may be any person and accompanying knowledge and capabilities that may provide value to an organization, such as in the form of work or other efforts.

The common logic module 106 allows the project manager to associate and disassociate required competencies with a task, to search tasks for associated competencies and to search human resources by competencies. Each of these functions is described in more detail below.

The relational database 110 includes tables that facilitate the association of competencies with tasks and with team members and facilitate the searches by competency and/or task described above.

In example embodiments, human resources, projects, tasks, and competencies are represented as database objects. In the following a database object may be any collection of data, such as data pertaining to a particular financial account, asset, employee, contact, and so on. Examples of database objects include, but are not limited to, records, tables, or other database entities corresponding to accounts receivables, products, employees, customers, business resources, and so on.

In order for the project manager to perform the associate/disassociate function, the project management application provides for the selection of competencies from a list of competencies. In most cases the project manager knows what competencies are used in a task when the task is defined. Therefore, with minimum effort, the scope of competencies can be defined at the time of task creation. This feature can be optional, however, and the project manager can create projects and tasks without defining the set of competencies.

In this example embodiment, to ensure that the right competencies are associated with the task, the task owners can add/edit/remove competencies assigned to a task. Task owners can modify tagged competencies only on their assigned tasks. Existing collaborative task management applications usually provide an interface that allows a team member to review assigned tasks and update progress. In the described example embodiments, a team member can tag an assigned task with competencies that the team member wishes to add or delete using the same interface.

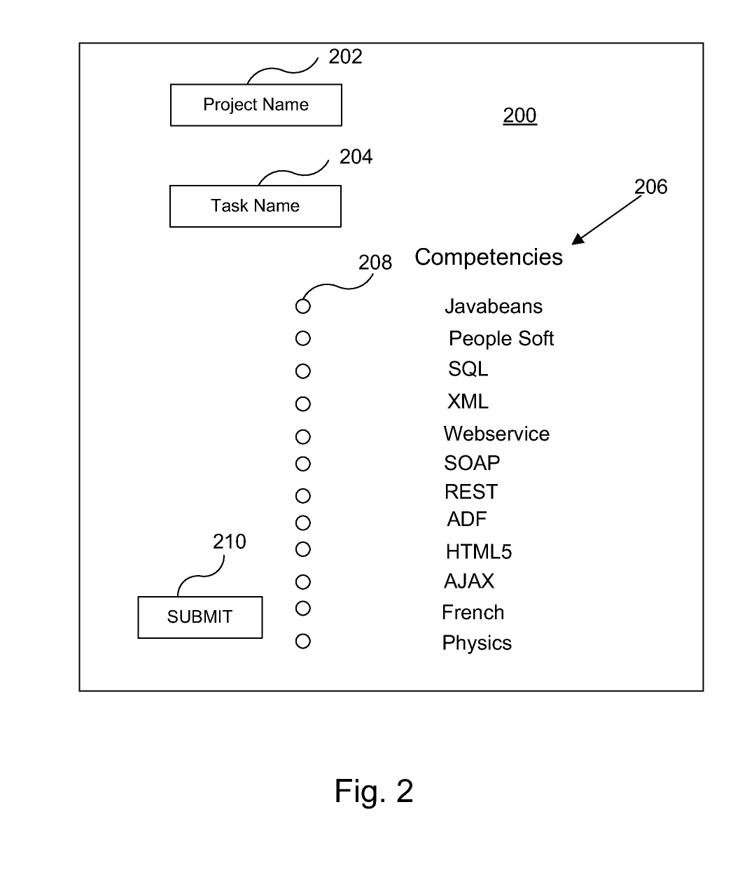

FIG. 2 depicts an example GUI widget 200 for associating competencies with a task required to complete a project. FIG. 2 depicts a first field 202 for entering the project name, a second field 204 for entering the task name, a pre-seeded competency list 206 including radio buttons 208 next to each competency in the list, and a submit control 210.

In practice, the project manager fills out the project name and task name in the first and second fields, clicks the radio buttons next to the competencies to be assigned to the task and then clicks the submit field to associate selected competencies with the task.

Subsequent additions or deletions of competencies for a given task are made by retrieving the widget for the task and clicking the radio buttons to add or delete competencies.

In some embodiments team members who are owners of a task are given permission to add or delete competencies to their owned task. Such permission can be given by a manager, for example the project manager, having authority to grant permissions.

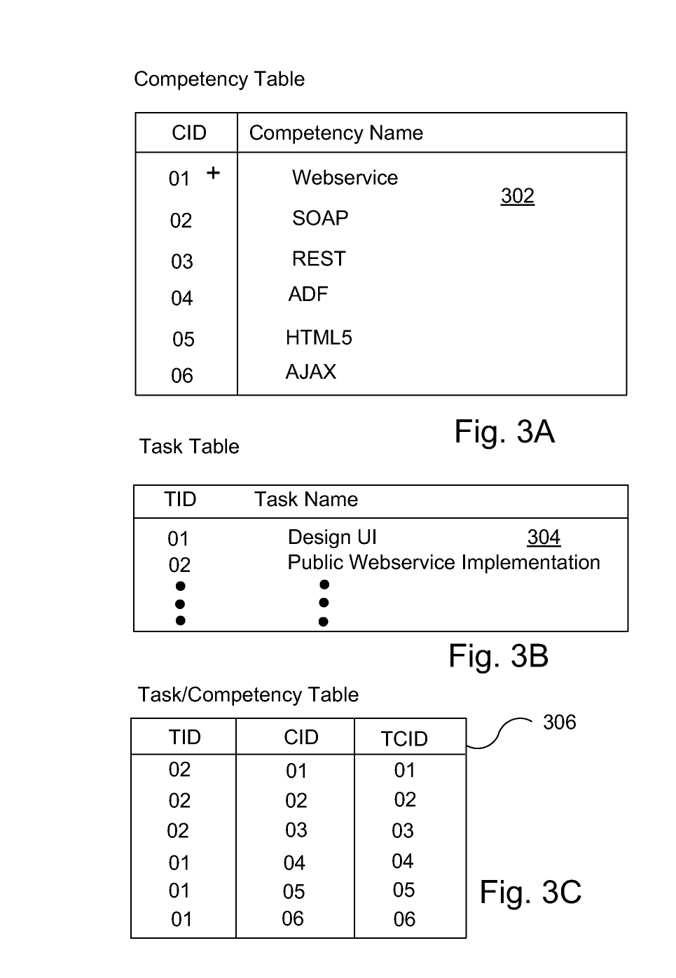

FIGS. 3A-3C depict database tables of the relational database configured to support the association and disassociation of competencies to a task.

FIG. 3A depicts a competency database table 302 in the relational database 110 configured to store the pre-seeded lists of competencies. Each row in the competency table includes a unique competency identifier (CID) attribute and competency name attribute. The CID is the primary key. The competency database table 302 may have competencies added or deleted by a manager having suitable permissions.

FIG. 3B depicts a task database table 304 that includes rows having a unique task identifier (TID) attribute and a task name attribute. The TID is the primary key.

FIG. 3C depicts a task/competency table 306 that is configured to associate selected competencies with tasks. Each row in the task/competency table 306 includes a TID referencing the task database table, a CID referencing the competency database table and a task/competency identifier (TCID). The TCID is the primary key.

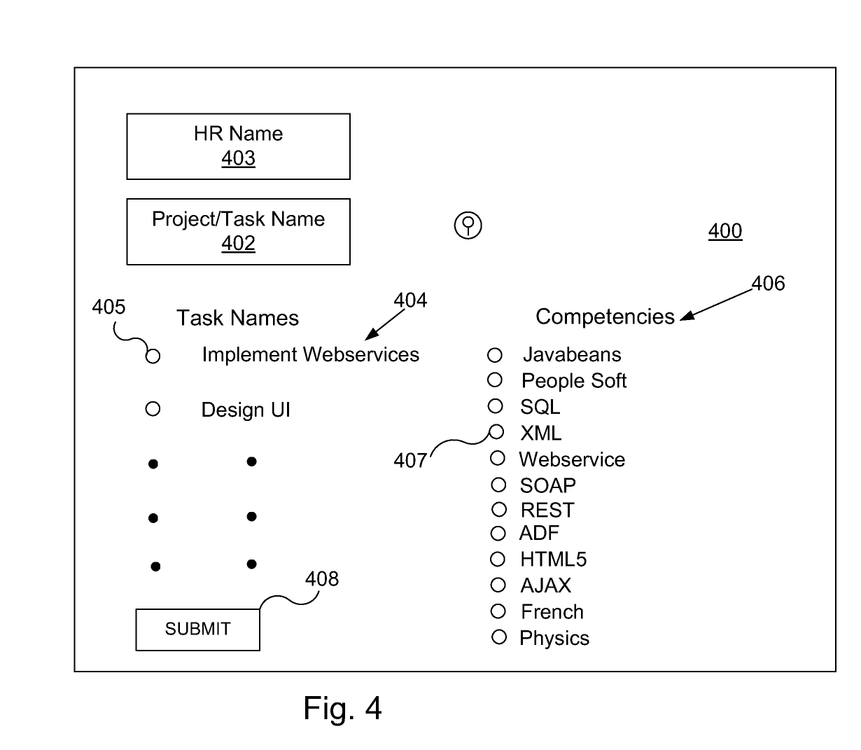

FIG. 4 depicts a search UI widget 400 used to search the database tables. The search UI widget 400 includes a project/task name field 402 for specifying the project or task name, a human resource name field 403 for specifying the name of a particular human resource, a list of task names 404 including radio buttons 405 next to each task name, a task competencies list 406 including radio buttons 407 next to each competency in the list, and a submit control 408.

In practice, the project manager may use the UI widget 400 to enter the project or task name, the human resource name and/or the tasks and competencies required of human resources or tasks. The submit button is then selected to implement a desired search.

A first type of search is to search by competency name to find human resources or tasks having specified competencies. In this case the radio buttons 407 next to specified competencies are selected and when the submit button is selected a list of human resources or tasks having the specified competencies is returned.

A second type of search is to search by the name of a particular human resource in order to find competencies associated with the particular human resource. In this case the name of the human resource is entered in the human resource name field 403 and when the submit button is selected a list of competencies associated with the human resource is returned.

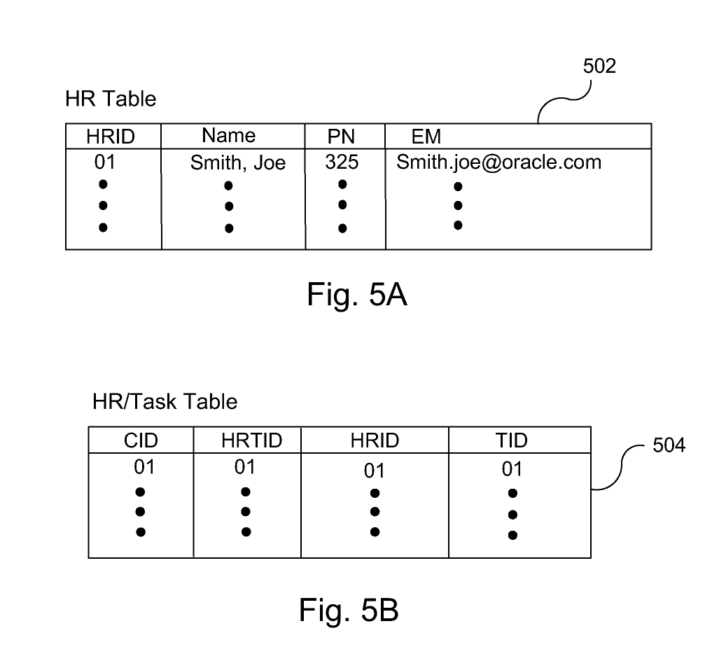

FIGS. 5A-B depict database tables in the relational database configured to support the search functions described above.

FIG. 5A depicts a human resource table 502 that includes rows having a human resource identifier (HRID) and personal data attributes such as name, phone number, email address and so on.

FIG. 5B depicts a human resource/task table 504 that includes rows having a human resource/task identifier (HRTID), an HRID attribute referencing the human resource database table 502, a TID attribute referencing the task database table 304 and a CID attribute referencing the competencies database table 302. The HRTID is the primary key. This table associates tasks and human resources and supports the searches described above. The human resource/task table 504 is populated when a project manager assigns team members to tasks using the project management application.

The common logic 106 utilizes the PM module 108 and relational database 110 to identify human resources having the specified competencies and/or who have worked on specified tasks and the results are formatted and presented to the project manager by the GUI module 104.

By storing the information described above, this example embodiment allows users to search for human resources having particular competencies using the project management application without leaving the application. The searches can be implemented using a popup interface or a global search interface.

Once the task is tagged with a set of competencies, a brief task description of the competency scope can be found in the search area. In this example, this search area is a common component so that it can be used with different projects being managed using the project management application. It is important to provide search capability in the project management application in order for the user to avoid the scenario where the user must visit multiple different applications.

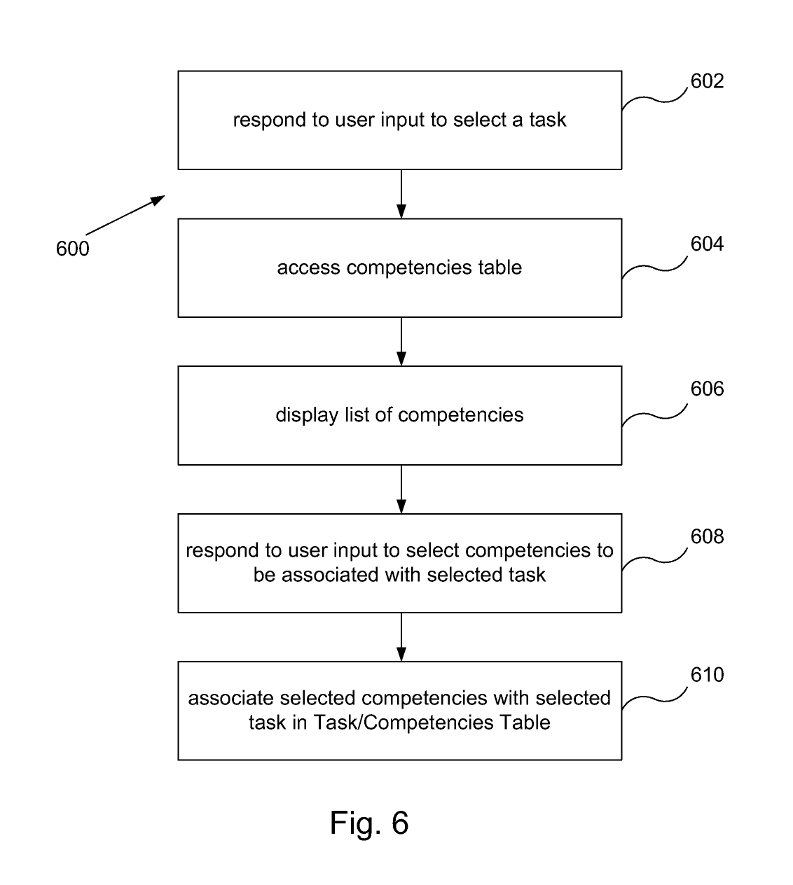

FIG. 6 is a flowchart 600 depicting the steps performed by the processor to associate/disassociate competencies with a selected task.

In process step 602, the processor responds to user input to select a task to be included in the project. In process step 604, the processor accesses the competencies database table 302 and in process step 606 displays the list of competencies stored in the competencies database table 302.

In process step 608, the processor responds to user input to select competencies to be associated with the selected task and in step 610 the processor associates selected competencies with the selected task in the task/competency database table 306.

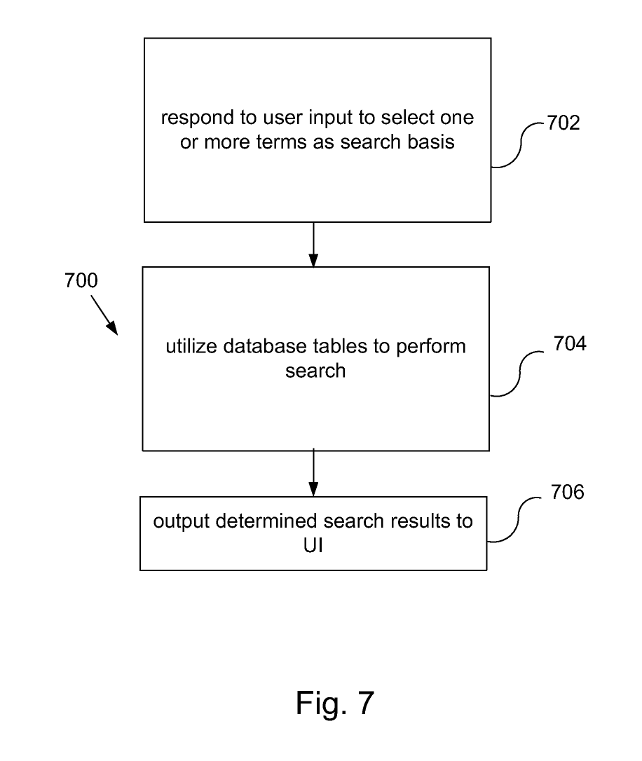

FIG. 7 is an example flowchart 700 depicting the steps performed by the processor to search the database tables.

In process step 702 the processor responds to user input to select one or more terms as a search basis.

In process step 704 the processor utilizes the database table to perform a search based on the one or more selected terms.

In process step 706 the processor outputs the search result to the UI.

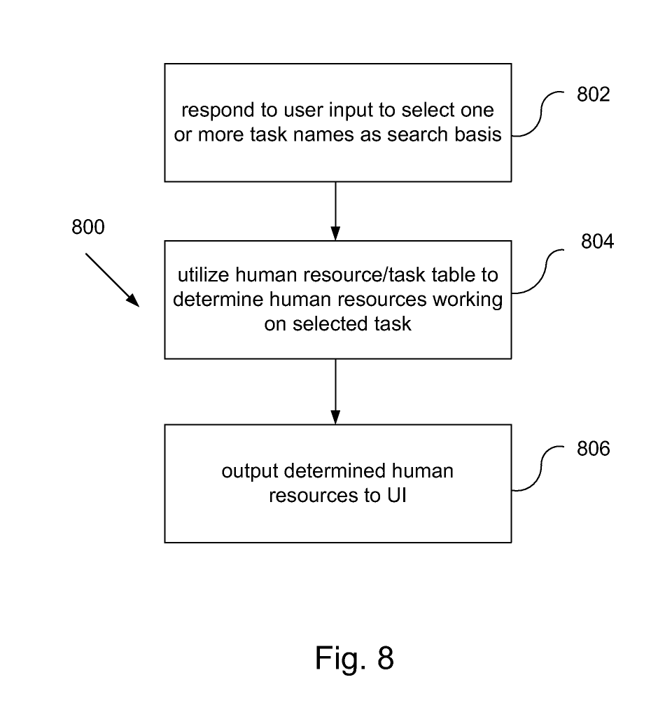

FIG. 8 is an example flowchart 800 depicting steps performed by the processor to search by task name to find human resources working on a specified task.

In process step 802 the processor responds to user input to select one or more task names as the basis of a search. In process step 804 the processor utilizes the human resource/task table 504 to determine human resources working on the specified tasks.

In process step 806 the processor outputs the determined human resources to the UI.

In one embodiment, the user input to implement the searches described with reference to FIGS. 7 and 8 may be provided using the UI widget depicted in FIG. 4.

Practical examples of using one or more embodiments will now be described.

In a first example, a team member logs on to a task management page to see a newly assigned task. In this example, the team member finds a new task named “public webservice implementation”. The team member understands what should be done but wants to find an expert having competencies relevant to the technology area to get advice and finish the task quickly. The team member can search the competency names required to complete the task, e.g., webservice, SOAP, REST and so on, on the same task management page.

The search result shows a human resource (person's) name, the task that the human resource worked on, the task duration, and a brief description of the task. At this moment, the team member can identify an expert. In some embodiments, the task management solution provides collaboration functionality so that the team member can initiate a web chat or conversation with the found expert from same page used to conduct the search.

In a second example, the project manager has a new hire and wants to assign the new hire to a UI implementation task. However, the project manager also wants to assign an expert to his team to ensure the quality of product while ensuring that the new hire learns the technology. The project manager creates a task and searches by the technology that will be used to complete the task, for example ADF, HTML5, AJAX, etc. The search result shows the human resources who worked on a queried competency and task description. The project manager can quickly go through the list and find the right human resource. He can the click the human resource's name and choose “Assign this person to task”.

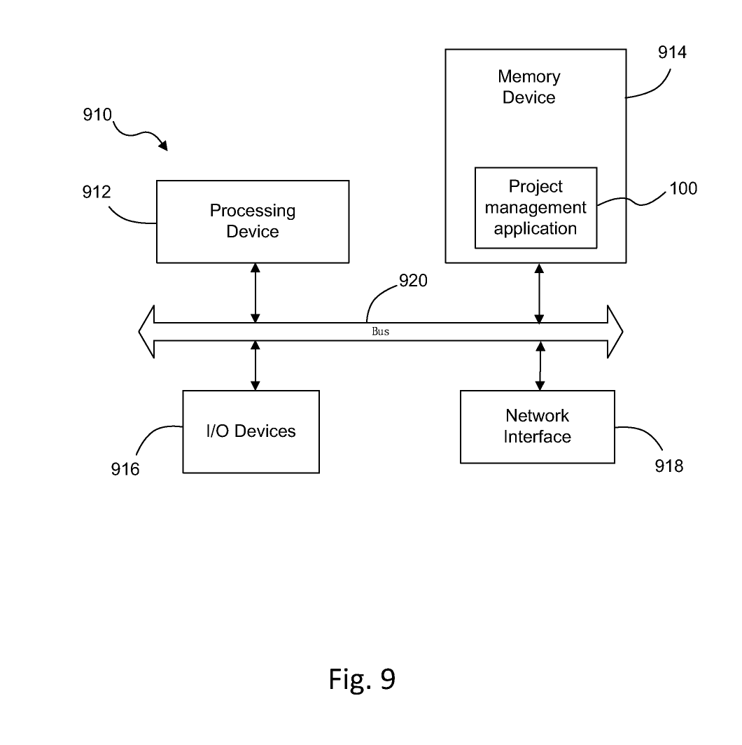

FIG. 9 is a block diagram of an example embodiment of a computer system 910 that can be used to implement the example embodiments described herein. In this embodiment, computer system 910 includes a processing device 912, a memory device 914, input/output (I/O) devices 916, and a network interface 918, each interconnected via a bus 920. Processing device 912 may be a general-purpose or specific-purpose processor or microcontroller. Computer system 910 can be configured from multiple devices in multiple locations.

In this embodiment, memory device 914 is configured to store the project management application 100. Memory device 914 may include one or more internally fixed storage units, removable storage units, and/or remotely accessible storage units. The storage units can be configured to store information, data, instructions, and/or software code. The storage units may include any combination of volatile memory and/or non-volatile memory such a DRAM, disc drives, flash memory, SRAM, etc.

Memory device 914 can also store program code that enables processing device 912 to execute procedures for enabling associating competencies with tasks and searching for competencies associated with team members assigned to tasks. Various logical instructions or commands may be included in the program code for performing these functions. The embodiments of the project management application described in the present disclosure can be implemented in hardware, software, firmware, or a combination thereof. When implemented in software or firmware, project management application 100 can be stored in memory device 914 and executed by processing device 912. When implemented in hardware, the project management circuit and systems can be implemented in processing device 912 using discrete logic circuitry, an application specific integrated circuit (ASIC), a programmable gate array (PGA), a field programmable gate array (FPGA), other suitable logic circuit, or any combination thereof.

The project management application and other circuitry and systems, which can be stored partially or fully in memory device 914, and any other software, programs, or computer code including executable logical instructions as described herein, can be embodied in non-transitory computer readable media for execution by any suitable processing device, such as processing device 912. The non-transitory computer readable media as described herein can include one or more suitable physical media components that can store the software, programs, or computer code for a measurable length of time.

I/O devices 916 may include input mechanisms such as keyboards, keypads, cursor control devices, or other data entry devices for entering information in memory device 914. I/O devices 916 also include output devices, such as computer monitors, audio output devices, printers, or other peripheral devices for communicating information to a user.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices and field programmable gate arrays. Optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material within the essential scope and spirit.

We claim:

1. A method, performed by one or more processors, comprising:
associating, in response to user input to a user interface (UI) of a project management application and using the one or more processors, a human resource as a team member of a specified task of a project;
associating, in response to user input to the UI of the project management application and using the one or more processors, selected competencies to the specified task;
associating, in response to user input to the UI of the project management application and using the one or more processors, one or more of the selected competencies to the human resource; and
searching, using the one or more processors and in response to user input to a search widget displayed in the UI of the project/management application, for relationships between associated tasks, competencies and human resources.

2. The method of claim 1 further comprising:
associating human resources, task names and competencies in database tables of a relational database.

3. The method of claim 1 where searching, using the one or more processors, comprises:
searching by competency name to determine human resources associated with a competency.

4. The method of claim 1 where searching, using the one or more processors, comprises:
searching by human resource name to determine competencies associated with a human resource.

5. The method of claim 1 where associating, in response to user input to the UI of the project management application and using the one or more processors, selected competencies to the specified task further comprises:
authorizing a team member to associate to the specified task.

6. The method of claim 1 where competencies include technology fields and skills.

7. The method of claim 1 further comprising:
displaying the search widget as a pop-up in the UI of the project management application.

8. The method of claim 2 further comprising:
maintaining the database table using the project management application.

9. The method of claim 1 where searching, using the one or more processors, comprises:
searching by task name to find competencies used in similar tasks.

10. The method of claim 1 where searching, using the one or more processors, comprises:
searching by task name to find human resources assigned to specific tasks.

11. The method of claim 1 where searching, using the one or more computers, comprises:
searching by human resource name to determine to which tasks the human resource is/has been assigned.

12. The method of claim 1 where searching, using the one or more computers, comprises:
searching by competency name to determine which tasks are associated with that competency.

13. A non-transitory computer readable storage medium comprising encoded program code for execution by one or more computer processors on a computer, the program code when executed is executable to perform the acts of:
associating, in response to user input to a user interface (UI) of a project management application, a human resource as a team member of a specified task of a project;
associating, in response to user input to the UI of the project management application, selected competencies to the specified task;
associating, in response to user input to the UI of the project management application, one or more of the selected competencies to the human resource; and
searching, in response to user input to a search widget displayed in the UI of the project/management application, for relationships between associated tasks, competencies and human resources.

14. The non-transitory computer readable storage medium of claim 13 with the program when executed further performing the act of:
associating human resources, task names and competencies in database tables of a relational database.

15. The non-transitory computer readable storage medium of claim 13 with the program when executed further performing the act of:
searching by competency name to determine human resources associated with a competency.

16. The non-transitory computer readable storage medium of claim 13 with the program when executed further performing the act of:
searching by human resource name to determine competencies associated with a human resource.

17. The non-transitory computer readable storage medium of claim 13 with the program when executed further performing the act of:
searching by task name to find competencies used in similar tasks.

18. The non-transitory computer readable storage medium of claim 13 with the program when executed further performing the act of:
searching by task name to find human resources assigned to specific tasks.

19. An apparatus comprising:
one or more processors; and
logic encoded in one or more non-transitory computer readable media for execution by the one or more processors and with the one or more processors, when executing the logic, performing the acts of:
associating, in response to user input to a user interface (UI) of a project management application, a human resource as a team member of a specified task of a project;
associating, in response to user input to the UI of the project management application, selected competencies to the specified task;
associating, in response to user input to the UI of the project management application, one or more of the selected competencies to the human resource; and
searching, in response to user input to a search widget displayed in the UI of the project/management application, for relationships between associated tasks, competencies and human resources.

20. The apparatus of claim 19 with the logic, when executed, further performing the act of:
searching by competency name to determine human resources associated with a competency.
